(19) United States
(12) Patent Application Publication
(10) Pub. No.: US 2016/0181925 A1
(43) Pub. Date: Jun. 23, 2016

(54) BIDIRECTIONAL DC-DC CONVERTER

(71) Applicant: NATIONAL CHUNG SHAN INSTITUTE OF SCIENCE AND TECHNOLOGY, Longtan Township (TW)

(72) Inventors: HSUANG-CHANG CHIANG, LONGTAN TOWNSHIP (TW); KUO-KUANG JEN, LONGTAN TOWNSHIP (TW); GWO-HUEI YOU, LONGTAN TOWNSHIP (TW); KE-CHIH LIU, LONGTAN TOWNSHIP (TW)

(21) Appl. No.: 14/573,014

(22) Filed: Dec. 17, 2014

(51) Int. Cl. H02M 3/335

(52) U.S. Cl. CPC H02M 3/33507

(57) ABSTRACT

A bidirectional DC-DC converter applies to a charging and discharging system equipped with a battery and especially to power fluctuations arising from the charging and discharging of the battery. The bidirectional DC-DC converter has a first full-bridge switching unit, transformer, resonance unit, second full-bridge switching unit, and frequency change control module. The first full-bridge switching unit connects with a first DC power source. The transformer has a primary side connected to the first switching unit to receive a power from the first DC power source and has a secondary side connected to the second full-bridge switching unit. The resonance unit connects with the transformer's secondary-side winding and receives power to produce resonance. The second full-bridge switching unit connects with a second DC power source. The frequency change control module instructs the switching units to perform bidirectional buck-boost switching and changes the operating frequency to adjust voltage gain.

### FIELD OF TECHNOLOGY

The present invention relates to DC-DC converters, and more particularly, to a bidirectional DC-DC converter for use in a charging and discharging system.

### BACKGROUND

A unidirectional DC-DC converter is not only an indispensable power converter of a conventional power conversion system but is also a power converter in widest use. The unidirectional DC-DC converter comprises a buck converter, a boost convert, and a buck-boost converter which are grounded at one end in a non-insulated manner, and is often disposed between a utility electricity source and a load device. The bidirectional DC-DC converter also widely applies to a battery-equipped charging and discharging system, such as an uninterruptible power system, a battery power-storing system, a grid-style power-storing system, an inverter, a charger, an uninterruptible power supply (UPS), an on-board charger, a mixed power generating system, and a microgrid system. The input voltage is restrained by the battery voltage charging and discharging state and thus fluctuates greatly. The instability in voltage is likely to cause damage to electrical appliances.

A conventional buck-boost converter has an inverter whose output end is provided with a low-frequency transformer for effectuating insulation and voltage level conversion; as a result, the conventional buck-boost converter is disadvantageously rendered bulky, heavy, and inefficient. Another conventional high-frequency transformer, which is compact and lightweight, has a bidirectional DC-DC converter framework and is characterized in that: although it is easy to control, its input voltage varies with the battery voltage; the number of turns of the winding of a conventional transformer is designed according to the minimum battery voltage; hence, when the battery voltage reaches its maximum, the input voltage is likely to be overly high, and thus it necessitates components which tolerate high voltages, thereby adding to the system costs and increasing conduction loss; in addition to the bidirectional DC-DC converter framework, it comes with a current source push-pull circuit structure whose input end has an inductor capable of generating a current source, and thus it requires a switch buffer circuit for decreasing a voltage surge produced at the instant of switch cut-off; to augment high-efficiency recycle leakage inductance energy and allow the switch to undergo zero voltage switching (ZVS), the prior art discloses an additional clamp circuit, but it brings about a drawback, that is, in a high-voltage application scenario, the switch voltage is overly high. As a result, although a conventional DC-DC converter series-connected buck-boost converter solves known problems with large variations in a battery voltage and high-voltage application, it still has drawbacks, for example, the need for augmenting a primary circuit in a series-connected manner at the expense of operation efficiency and manufacturing costs.

Taiwan invention patent 1397250, entitled bidirectional full-bridge zero voltage-zero current DC-DC converter, discloses that the bidirectional full-bridge zero voltage-zero current DC-DC converter essentially comprises an input inductor, a transformer, a load device, a plurality of first switch components, and a plurality of second switch components. The input inductor converts an input voltage into a DC input current. The transformer comprises a primary-side winding and a secondary-side winding. The load device connects with a power output end during a discharging process. The plurality of first switch components each comprise a parasitic capacitance and a parasitic diode and connect with the primary-side winding of the transformer to effectuate a switch between conduction and cut-off at zero voltage and zero current because of the characteristics of a resonance circuit. Likewise, the plurality of second switch components each comprise a parasitic capacitance and a parasitic diode, connect with the secondary-side winding of the transformer, and convert AC power supplied by the transformer into a DC power. The input inductor connects with the first switch components and the second switch components through a resonance capacitor and a capacitor, respectively. Due to the aforesaid framework, the conduction loss of the main switches in the circuit framework is reduced, as both conduction and cut-off are operating at the state of zero voltage-zero current.

As indicate by the above prior art, the input voltage of conventional bidirectional DC-DC converters is restricted in the state of battery voltage charging and discharging and thus manifests large fluctuations. As a result, they require components which tolerate high voltages, thereby adding to the system costs and incurring high conduction loss. In this regard, even though switch cut-off surge is reduced by a switch buffer circuit, the problem with overly high switch voltage remains unsolved. If buck-boost converters are connected in series, the operation efficiency will decrease, thereby adding to the manufacturing costs. Although the circuit framework of Taiwan invention patent 1397250 cuts costs and reduces conduction loss, it is still inapplicable to a battery-equipped charging and discharging system. In particular, when the input voltage varies greatly because of battery voltage charging and discharging, it is necessary to stabilize the output voltage and ensure that all the switches can undergo zero voltage switching in order to reduce conduction loss. Given the need for cost saving and enhancement of conversion performance, there is still room for improvement in the prior art.

### SUMMARY

In view of the aforesaid drawbacks of the prior art, it is an objective of the present invention to provide a bidirectional DC-DC converter which applies to a battery-equipped charging and discharging system and is connected between two DC power sources to perform bidirectional discharging and charging, stabilize an output voltage, and tolerate large fluctuations of an input voltage, so as to enhance voltage conversion performance and reduce power loss.

In order to achieve the above and other objectives, the present invention provides a bidirectional DC-DC converter comprising a first full-bridge switching unit, a transformer, a resonance unit, a second full-bridge switching unit, and a frequency change control module. The first full-bridge switching unit has first through fourth switches and forms two first nodes and two second nodes. The first nodes connect with a first DC power source. The transformer has a primary-side winding and a secondary-side winding. The primary-side winding is connected to the two second nodes of the first full-bridge switching unit. The resonance unit has two first ends and two second ends, wherein the first ends connect with the secondary-side winding of the transformer and receive a power to produce resonance. The second full-bridge switching unit has fifth through eighth switches and forms two third nodes and two fourth nodes, wherein the fourth nodes are connected to the two second ends of the resonance unit, and the third nodes connect with a second DC power source. The frequency change control module connects with the first through fourth switches of the first full-bridge switching unit and the fifth through eighth switches of the second full-bridge switching unit.

In an embodiment, the resonance unit has a resonance inductor and a resonance capacitor. The first ends of the resonance unit include an end of the resonance inductor and an end of the resonance capacitor. The two second ends of the resonance unit include another end of the resonance inductor and another end of the resonance capacitor.

In an embodiment, a filter capacitor is disposed between the second DC power source and the third nodes of the second full-bridge switching unit.

In an embodiment, the frequency change control module has a controller, an oscillator, a first triggering unit, a first driving unit, a second triggering unit, and a second driving unit, with the controller connected to the oscillator, the first triggering unit to the oscillator and the first driving unit, and the second triggering unit to the oscillator and the second driving unit.

In an embodiment, the frequency change control module further comprises a pulse width modulation module and a determination module. The oscillator connects with the first triggering unit by the determination module. The pulse width modulation module connects with the oscillator and the determination module.

In an embodiment, the first through fourth switches of the first full-bridge switching unit are each a power transistor, whereas the fifth through eighth switches of the second full-bridge switching unit are each a power transistor.

In an embodiment, the controller is a current controller.

In an embodiment, the oscillator is a voltage control oscillator.

In an embodiment, power transistors of the first full-bridge switching unit and the second full-bridge switching unit are each an enhancement-mode metal-oxide-semiconductor field-effect transistor (MOSFET).

In an embodiment, the first DC power source is a chargeable and dischargeable battery, and the second DC power source is connected to an inverter.

According to the present invention, the frequency change control module detects the state of each DC power source and instructs the first full-bridge switching unit and the second full-bridge switching unit to operate in accordance with the state of each DC power source, reduces switch loss by zero voltage switching, changes the operating frequency and receives a control signal so as to adjust a voltage gain ratio and thus adapt to any great change in input voltage, and controls the first full-bridge switching unit and the second full-bridge switching unit to perform boost discharging or buck charging so as to perform bidirectional power conversion. Accordingly, the bidirectional DC-DC converter of the present invention enhances voltage conversion performance and reduces power loss.

### BRIEF DESCRIPTION

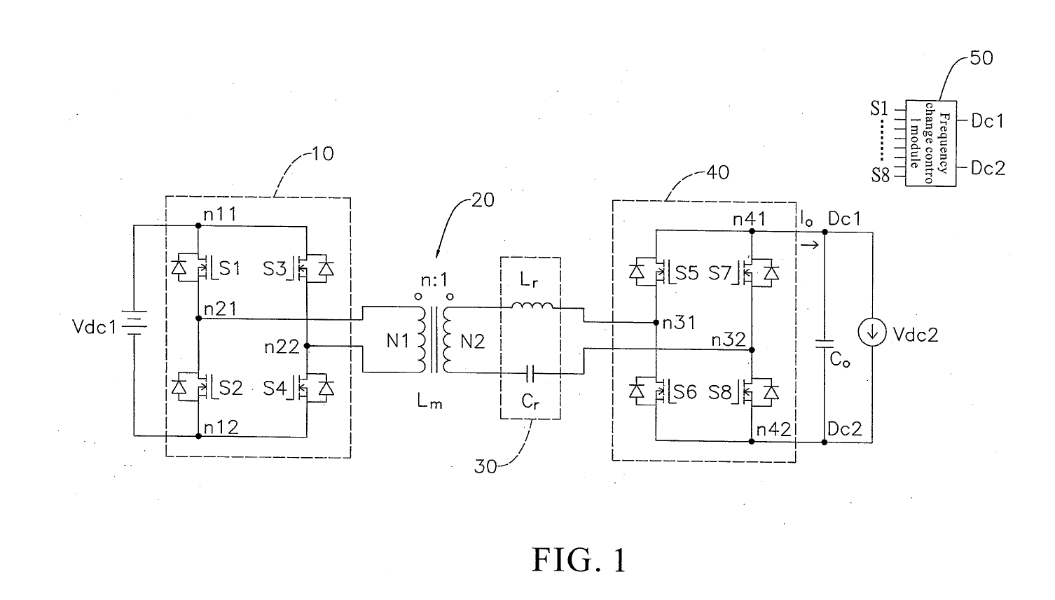

FIG. 1 is a circuit diagram of a bidirectional DC-DC converter according to the first embodiment of the present invention;

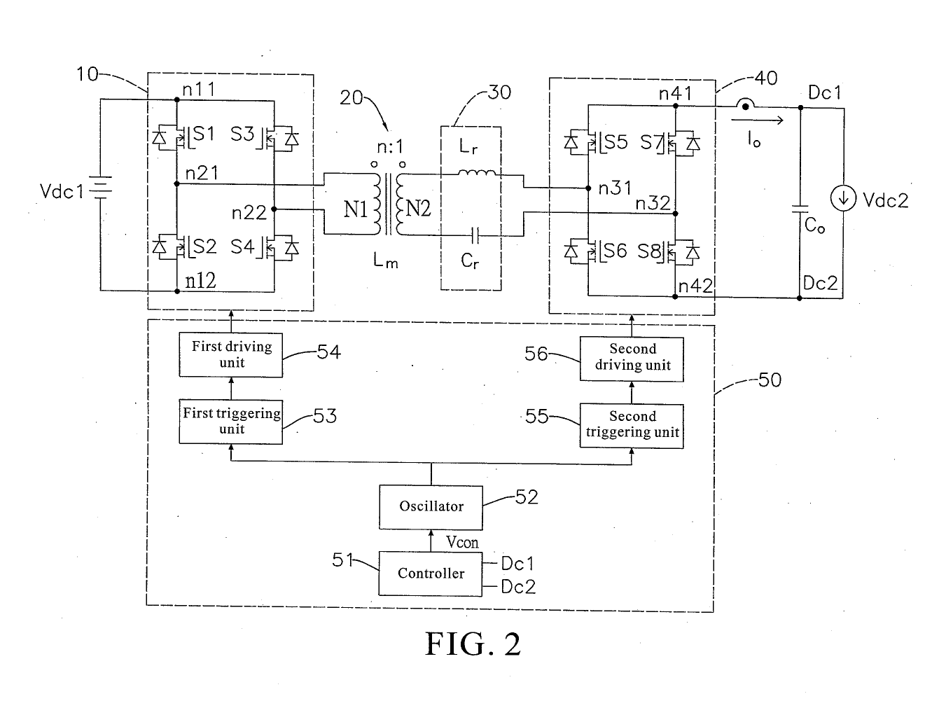

FIG. 2 is a circuit diagram of the bidirectional DC-DC converter according to the second embodiment of the present invention; and

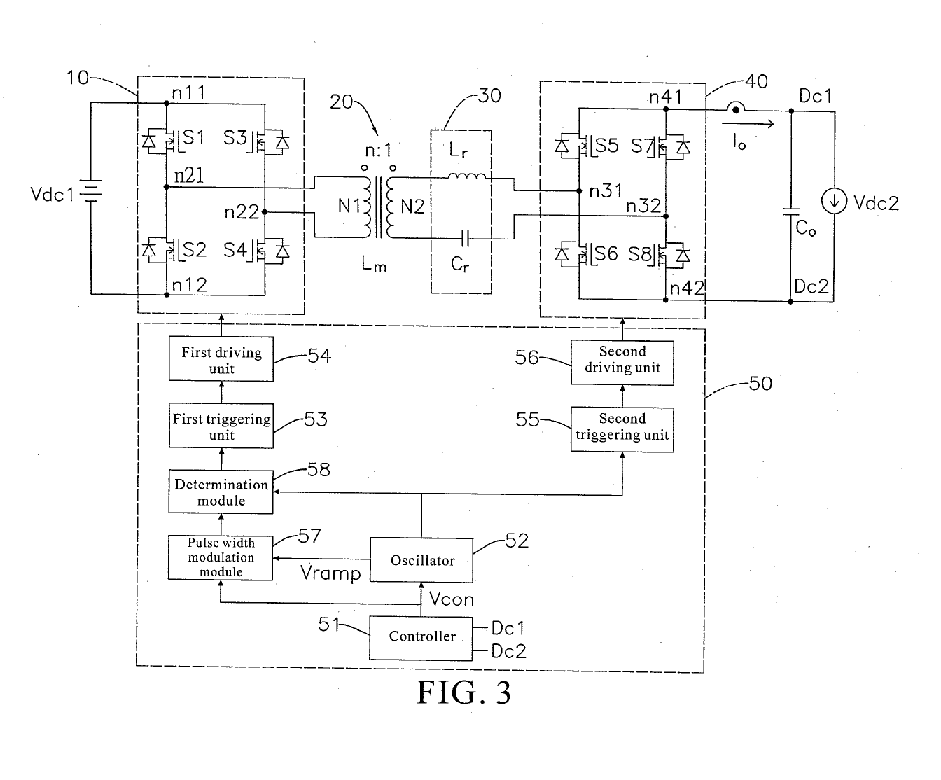

FIG. 3 is a circuit diagram of the bidirectional DC-DC converter according to the third embodiment of the present invention.

### DETAILED DESCRIPTION

Referring to FIG. 1, there is shown a circuit diagram of a bidirectional DC-DC converter according to the first embodiment of the present invention. The bidirectional DC-DC converter applies to a battery-equipped charging and discharging system and especially to stabilizing an output voltage despite large fluctuations of an input voltage. The bidirectional DC-DC converter comprises a first DC power source Vdc1, a second DC power source Vdc2, a first full-bridge switching unit 10, a transformer 20, a resonance unit 30, a second full-bridge switching unit 40, and a frequency change control module 50. In this embodiment, the first DC power source Vdc1 is a chargeable and dischargeable battery, and the second DC power source Vdc2 is connected to an inverter (not shown).

The first full-bridge switching unit 10 comprises first through fourth switches S1˜S4 and forms two input-oriented first nodes n11, n12 and two output-oriented second nodes n21, n22. The first nodes n11, n12 are connected to the first DC power source Vdc1. The second nodes n21, n22 are provided in the form of series-connected nodes of the first and second switches S1, S2 and series-connected nodes of the third and fourth switches S3, S4. The first nodes n11, n12 are provided in the form of parallel-connected nodes of the first and third switches S1, S3 and the second and fourth switches S2, S4. In this embodiment, the first through fourth switches S1˜S4 of the first full-bridge switching unit 10 are each a power transistor, and the power transistors are each an enhancement-mode metal-oxide-semiconductor field-effect transistor (MOSFET).

The transformer 20 has a primary-side winding N1 and a secondary-side winding N2. The primary-side winding N1 is connected to two second nodes n21, n22 of the first full-bridge switching unit 10. In this embodiment, the transformer 20 further has a magnetizing inductance Lₘ, wherein the larger the number of the turns of the winding of the transformer 20, the larger the magnetizing inductance Lₘ, and the stronger the current generated.

The resonance unit 30 has two first ends and two second ends. The first ends are connected to the secondary-side winding N2 of the transformer 20 and receives a power from the DC power source to produce resonance. In this embodiment, the resonance unit 30 essentially comprises a resonance inductor Lᵣ and a resonance capacitor Cᵣ. The two first ends of the resonance unit 30 are an end of the resonance inductor Lᵣ and an end of the resonance capacitor Cᵣ. The two second ends of the resonance unit 30 are another end of the resonance inductor Lᵣ and another end of the resonance capacitor Cᵣ.

The second full-bridge switching unit 40 essentially comprises fifth through eighth switches S5˜S8 and forms two input-oriented third nodes n31, n32 and two output-oriented fourth nodes n41, n42. The two output-oriented fourth nodes n41, n42 are connected to the two second ends of the resonance unit 30, whereas the two input-oriented third nodes n31, n32 are connected to the second DC power source Vdc2. The third nodes n31, n32 are provided in the form of series-connected nodes of the fifth and sixth switches S5, S6 and series-connected nodes of the seventh and eighth switches S7, S8. The fourth nodes n41, n42 are provided in the form of parallel-connected nodes of the fifth and seventh switches S5, S7 and the sixth and eighth switches S6, S8.

In this embodiment, the fifth through eighth switches S5˜S8 of the second full-bridge switching unit 40 are each a power transistor. The power transistors are each an enhancement-mode metal-oxide-semiconductor field-effect transistor (MOSFET). A filter capacitor Cₒ is disposed between the second DC power source Vdc2 and two third nodes n31, n32 of the second full-bridge switching unit 40 to filter out noise. The filter capacitor Cₒ is parallel-connected to the second DC power source Vdc2.

The frequency change control module 50 is connected to the first through fourth switches S1˜S4 of the first full-bridge switching unit 10 and the fifth through eighth switches S5˜S8 of the second full-bridge switching unit 40. The frequency change control module 50 detects the state of the second DC power source Vdc2 and instructs the first full-bridge switching unit 10 and the second full-bridge switching unit 40 to operate in accordance with the state of the second DC power source Vdc2. Furthermore, the frequency change control module 50 reduce the power loss of the switches S1˜S8 by zero voltage switching. Moreover, the frequency change control module 50 not only changes the operating frequency and receives a control signal so as to adjust the voltage gain ratio and thus adapts to large fluctuations of the input voltage, but also controls the first full-bridge switching unit 10 and the second full-bridge switching unit 40 to perform boost discharging or buck charging so as to perform bidirectional power conversion. Accordingly, the bidirectional DC-DC converter in the second embodiment of the present invention enhances voltage conversion performance and reduces power loss.

Referring to FIG. 2, which shows the bidirectional DC-DC converter according to the second embodiment of the present invention. The second embodiment is substantially identical to the first embodiment in technical features except that in the second embodiment the frequency change control module 50 essentially comprises a controller 51, an oscillator 52, a first triggering unit 53, a first driving unit 54, a second triggering unit 55, and a second driving unit 56. The controller 51 is connected to the oscillator 52. The first triggering unit 53 is connected to the oscillator 52 and the first driving unit 54. The second triggering unit 55 is connected to the oscillator 52 and the second driving unit 56. The first driving unit 52 is connected to the first through fourth switches S1˜S4 of the first full-bridge switching unit 10. The second driving unit 56 is connected to the fifth through eighth switches S5˜S8 of the second full-bridge switching unit 40.

Due to the aforesaid structures, the controller 51 detects a current signal of the second DC power source Vdc2 and receives a control signal to thereby control the direction of power flow in accordance with the positive and negative levels of the control signal. The controller 51 sends an output signal Vcon to the oscillator 52 for controlling the oscillation frequency. The oscillator 52 sends to the first and second triggering units 53, 55 two signals which have a duty cycle of 50% or so and feature forward and reverse phases. With the enabled state being altered by the first and second triggering units 53, 55, the first and second driving units 52, 54 drive the first full-bridge switching unit 10 and the second full-bridge switching unit 40, respectively, to operate and thus perform boost discharging and buck charging on the first DC power source Vdc1 (such as a chargeable and dischargeable battery).

In this embodiment, the voltage (battery voltage) of the first DC power source Vdc1 falls into the range of 136V˜200V, whereas the voltage (output voltage) of the second DC power source Vdc2 equals 380V. The controller 51 is a current controller. The oscillator 52 is a voltage control oscillator (VCO). The frequency change control module 50 changes the operating frequency and receives a control signal. Hence, in the buck charging mode, the second DC power source Vdc2 attains an operating voltage conversion ratio M of 1˜1.47 under different powers. In the boost discharging mode, the first DC power source Vdc1 also attains another voltage conversion ratio M of 1˜0.68 by a frequency change.

Referring to FIG. 3, there is shown the bidirectional DC-DC converter according to the third embodiment of the present invention. The third embodiment is substantially identical to the second embodiment in technical features except that in the third embodiment the frequency change control module 50 further comprises a pulse width modulation module 57 and a determination module 58, with the oscillator 52 connected to the first triggering unit 53 by the determination module 58, and the pulse width modulation module 57 to the oscillator 52 and the determination module 58. The pulse width modulation module 57 receives the output signal Vcon from the controller 51 and receives a synchronous dentate wave signal (Vramp) from the oscillator 52. If the oscillation frequency of the oscillator 52 reaches a high frequency, the oscillator 52 will place a limit on the oscillation frequency by replacing the oscillation frequency with a rated oscillation frequency. The determination module 58 controls the first triggering unit 53 according to the output signal of the oscillator 52 and the PWM signal of the pulse width modulation module 57, so as to achieve the following: avoid augmenting the switching frequency when the power is low and thus preclude an overly large switching loss; reduce the switching frequency and augment the voltage gain; and strike a balance between voltage conversion and reduction of switching loss.

In conclusion, a bidirectional DC-DC converter of the present invention is characterized in that: a frequency change control module instructs a first full-bridge switching unit and a second full-bridge switching unit to operate in accordance with a power state and a control signal; power loss is reduced by zero voltage switching; the frequency change control module adjusts a voltage gain ratio so as to adapt to any great change in input voltage and controls the first and second full-bridge switching units to perform boost discharging and buck charging so as to perform bidirectional power conversion. Accordingly, the bidirectional DC-DC converter of the present invention enhances voltage conversion performance and reduces power loss.

What is claimed is:

1. A bidirectional DC-DC converter, comprising:
a first full-bridge switching unit having first through fourth switches and forming two first nodes and two second nodes, with the first nodes connected to a first DC power source;
a transformer having a primary-side winding and a secondary-side winding, with the primary-side winding connected to two second nodes of the first full-bridge switching unit;
a resonance unit having two first ends and two second ends, with the first ends connected to the secondary-side winding of the transformer and adapted to receive a power to produce resonance;
a second full-bridge switching unit having fifth through eighth switches and forming two third nodes and two fourth nodes, with the fourth nodes connected to two second ends of the resonance unit, and the third nodes to a second DC power source; and
a frequency change control module connected to the first through fourth switches of the first full-bridge switching unit and the fifth through eighth switches of the second full-bridge switching unit.

2. The bidirectional DC-DC converter of claim 1, wherein the resonance unit has a resonance inductor and a resonance capacitor, wherein the first ends of the resonance unit include an end of the resonance inductor and an end of the resonance capacitor, wherein the two second ends of the resonance unit include another end of the resonance inductor and another end of the resonance capacitor.

3. The bidirectional DC-DC converter of claim 2, wherein a filter capacitor is disposed between the second DC power source and the two third nodes of the second full-bridge switching unit.

4. The bidirectional DC-DC converter of claim 3, wherein the frequency change control module has a controller, an oscillator, a first triggering unit, a first driving unit, a second triggering unit, and a second driving unit, with the controller connected to the oscillator, the first triggering unit connected to the oscillator and the first driving unit, and the second triggering unit connected to the oscillator and the second driving unit.

5. The bidirectional DC-DC converter of claim 4, wherein the frequency change control module further comprises a pulse width modulation module and a determination module, with the oscillator connected to the first triggering unit by the determination module, and the pulse width modulation module connected to the oscillator and the determination module.

6. The bidirectional DC-DC converter of claim 5, wherein the first through fourth switches of the first full-bridge switching unit are each a power transistor, and the fifth through eighth switches of the second full-bridge switching unit are each a power transistor.

7. The bidirectional DC-DC converter of claim 6, wherein the controller is a current controller.

8. The bidirectional DC-DC converter of claim 7, wherein the oscillator is a voltage control oscillator.

9. The bidirectional DC-DC converter of claim 8, wherein power transistors of the first full-bridge switching unit and the second full-bridge switching unit are each an enhancement-mode metal-oxide-semiconductor field-effect transistor (MOSFET).

10. The bidirectional DC-DC converter of claim 1, wherein the first DC power source is a chargeable/dischargeable battery, and the second DC power source is connected to an inverter.

11. The bidirectional DC-DC converter of claim 2, wherein the first DC power source is a chargeable/dischargeable battery, and the second DC power source is connected to an inverter.

12. The bidirectional DC-DC converter of claim 3, wherein the first DC power source is a chargeable/dischargeable battery, and the second DC power source is connected to an inverter.

13. The bidirectional DC-DC converter of claim 4, wherein the first DC power source is a chargeable/dischargeable battery, and the second DC power source is connected to an inverter.

14. The bidirectional DC-DC converter of claim 5, wherein the first DC power source is a chargeable/dischargeable battery, and the second DC power source is connected to an inverter.

15. The bidirectional DC-DC converter of claim 6, wherein the first DC power source is a chargeable/dischargeable battery, and the second DC power source is connected to an inverter.

16. The bidirectional DC-DC converter of claim 7, wherein the first DC power source is a chargeable/dischargeable battery, and the second DC power source is connected to an inverter.

17. The bidirectional DC-DC converter of claim 8, wherein the first DC power source is a chargeable/dischargeable battery, and the second DC power source is connected to an inverter.

18. The bidirectional DC-DC converter of claim 9, wherein the first DC power source is a chargeable/dischargeable battery, and the second DC power source is connected to an inverter.
